(19) United States
(12) Patent Application Publication
(10) Pub. No.: US 2015/0115702 A1
(43) Pub. Date: Apr. 30, 2015

(54) VOLUTE SPRING FOR A FOOT BRAKE VALVE

(71) Applicant: Bendix Commercial Vehicle Systems LLC, Elyria, OH (US)

(72) Inventor: Duane R. Johnson, Wellington, OH (US)

(73) Assignee: Bendix Commercial Vehicle Systems LLC, Elyria, OH (US)

(21) Appl. No.: 14/066,247

(22) Filed: Oct. 29, 2013

(51) Int. Cl. B60T 15/04; B60T 13/26; B23P 15/00; F16F 1/08

(52) U.S. Cl. CPC B60T 15/043; F16F 1/08; B60T 13/268; B23P 15/001
USPC 303/56; 188/355; 29/890.12; 29/890.132

(57) ABSTRACT

A foot brake valve for operating a vehicle brake system associated with wheels of the associated vehicle includes a plunger, a primary piston, and a volute spring. The plunger is positioned based on a position of an associated brake pedal depressed by an operator for engaging an associated service brakes of the vehicle. The primary piston positioned based on a position of the plunger. The volute spring biases the primary piston against a depression of the brake pedal.

### BACKGROUND

The present invention relates to a vehicle foot brake valve. It finds particular application in conjunction with a spring used in a foot brake valve for assisting a driver's foot in modulating pressure delivered by the brake valve for applying a brake and will be described with particular reference thereto. It will be appreciated, however, that the invention is also amenable to other applications.

Vehicle brake systems include a foot brake valve. The foot brake valve controls delivery of compressed air to service brakes of the vehicle. For example, when a service brake application is desired, an operator of the vehicle depresses a brake pedal for actuating the foot brake valve, which in turn delivers compressed air for applying the service brakes. Foot brake valves include a modulation spring that controls, in response to an operator depressing the brake pedal, an amount of the compressed air delivered to the service brakes and, consequently, an amount of the service brake application.

Feedback from the modulation spring is sensed by the operator of the vehicle through the brake pedal. Vehicle operators become familiar with the feedback and tend to apply the brake pedal accordingly.

Conventional foot brake valves include modulation springs made of rubber. These conventional modulation spring are affected by temperature. More specifically, vehicle operators commonly sense different feedback from the brake pedal based on how the rubber modulation spring responds to different temperatures. Some springs made from different materials may not have feedback to which the driver has become accustomed.

The present invention provides a new and improved apparatus and method.

### SUMMARY

In one aspect of the present invention, it is contemplated that a foot brake valve for operating a vehicle brake system associated with wheels of the associated vehicle includes a plunger, a primary piston, and a volute spring. The plunger is positioned based on a position of an associated brake pedal depressed by an operator for engaging an associated service brakes of the vehicle. The primary piston positioned based on a position of the plunger. The volute spring biases the primary piston against a depression of the brake pedal.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a vehicle including a brake system in accordance with one embodiment of an apparatus illustrating principles of the present invention;

FIG. 2 illustrates a schematic representation of a foot brake valve in accordance with one embodiment of an apparatus illustrating principles of the present invention;

FIGS. 3-5 illustrate schematic representations of a volute spring in accordance with one embodiment of an apparatus illustrating principles of the present invention;

FIG. 6 is an exemplary methodology of manufacturing a foot brake valve in accordance with one embodiment illustrating principles of the present invention; and

FIG. 7 illustrates a schematic representation of a flat spring metal being wound around a mandrel in accordance with one embodiment of an apparatus illustrating principles of the present invention.

### DETAILED DESCRIPTION OF ILLUSTRATED EMBODIMENT

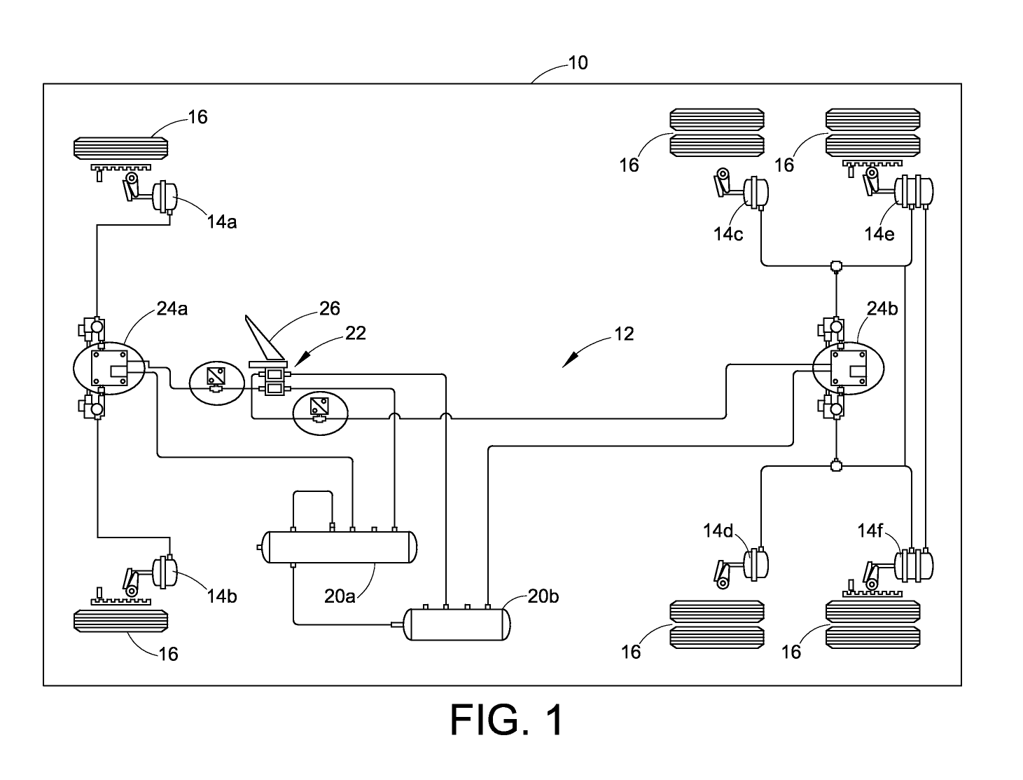

With reference to FIG. 1, a simplified component diagram of a vehicle 10 including an exemplary vehicle brake system 12 is illustrated in accordance with one embodiment of the present invention. The brake system 12 includes a plurality of brake chambers 14a, 14b, 14c, 14d, 14e, 14f (collectively 14) associated with respective wheels 16a, 16b, 16c, 16d, 16e, 16f (collectively 16) of the vehicle 10. At least one of a plurality of reservoirs 20a, 20b (collectively 20) stores compressed fluid (e.g., air), which is generated by a compressor (not shown). A foot brake valve 22 controls fluid communication of the compressed air from the at least one reservoir 20 to various ones of the brake chambers 14 via relay valves 24a, 24b (collectively, 24). The foot brake valve 22 includes a foot pedal 26 that is depressible by an operator of the vehicle to communicate the compressed air from the at least one reservoir 20 to the at least one brake chamber 14 for actuating service brakes of the vehicle 10.

The foot brake valve 22 selectively communicates the pressurized air to the at least one brake chamber 14 based on an amount the foot pedal 26 is depressed by the operator for selectively actuating service brakes of the vehicle 10. More specifically, as is commonly understood, depressing the foot pedal 26 of the vehicle 10 farther results in relatively more of the compressed air being passed to the at least one brake chamber 14 and, consequently, stronger applications of the service brakes.

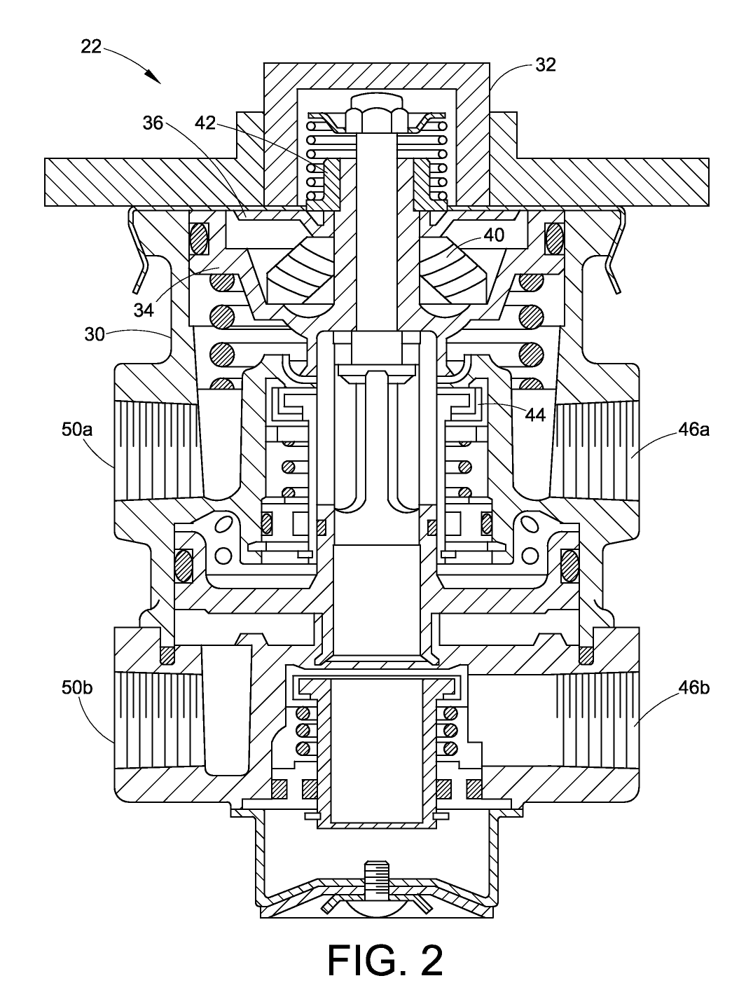

As discussed above, the foot brake valve 22 includes the foot pedal 26. As illustrated in FIG. 2, the foot brake valve 22 includes a housing 30. A plunger 32 passes through the housing 30 and is mechanically connected to the foot pedal 26 (see FIG. 1), which is maintained outside the housing 30. For example, when the foot pedal 26 (see FIG. 1) is depressed, the plunger 32 moves accordingly. Therefore, a position of the plunger 32 is based on a position of the foot pedal 26.

A primary piston 34 is retained in the housing 30 by a primary piston retainer 36. A retaining nut 42 holds the primary piston retainer 36 in place. The primary piston retainer 36 also serves as a spring seat. A modulation spring 40 is positioned in the housing 30 between the primary piston 34 and the primary piston retainer 36. The modulation spring 40 biases the plunger 32 against a depression of the foot pedal 26. The primary piston 34 is positioned based on a position of the plunger 32.

Movement of the foot pedal 26 and, consequently, the plunger 32 exerts force on the modulation spring 40 and the primary piston 34. The primary piston 34, in turn, acts on a primary inlet/exhaust valve 44 to selectively deliver the compressed air from at least one supply port 46a, 46b (collectively 46) to at least one delivery port 50a, 50b. For example, the primary piston 34 moves the primary inlet/exhaust valve 44 to selectively deliver the compressed air from the at least one reservoir 20 to the at least one brake chamber 14 via the at least one supply port 46, the at least one delivery port 50, and the at least one relay valve 24 for selectively applying the service brakes of the vehicle 10.

In one embodiment, the foot brake valve 22 is similar to the E-6® Brake Valve from Bendix Commercial Vehicle Systems LLC including a modulation spring 40 as described herein.

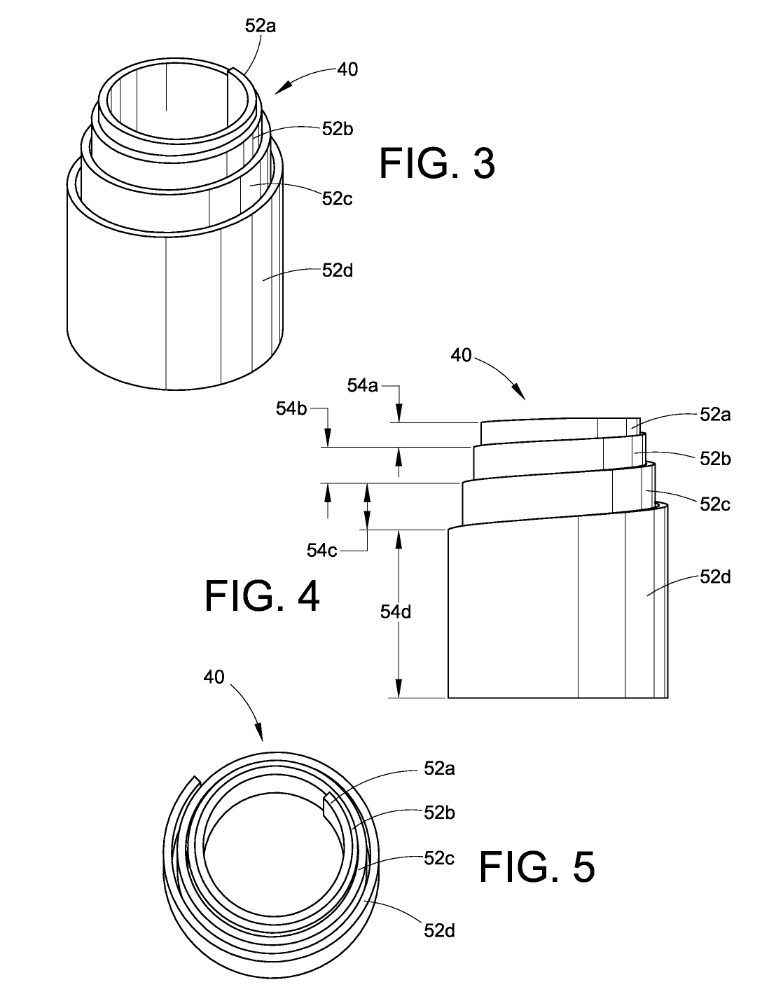

With reference to FIGS. 3, 4, and 5, in one embodiment, the modulation spring 40 is a volute spring. It is contemplated that the volute spring 40 is metal. Furthermore, in one embodiment, the volute spring 40 is steel.

As best seen in FIG. 3, the volute spring 40 is formed from a flat piece of spring steel. The flat piece of spring steel is formed into a plurality of coils 52. In the embodiment illustrated in FIGS. 3, 4, and 5, the coils 52 are concentric. In addition, the coils 52 are capable of telescoping within each other while not being forced against one another, thus permitting longer travel. More specifically, a first of the sub-coils 52a has a smaller diameter and is capable of slidably being received in a second of the sub-coils 52b; the second of the sub-coils 52b has a smaller diameter and is capable of slidably being received in a third of the sub-coils 52c; and the third of the sub-coils 52c has a smaller diameter and is capable of slidably being received in a fourth of the sub-coils 52d.

Although the coil 52 illustrated in FIGS. 3, 4, and 5 includes four sub-coils 52a, 52b, 52c, 52d, any number of sub-coils is contemplated.

The flat piece of spring steel is chosen to exhibit a spring characteristic, which determines how much the sub-coils 52a, 52b, 52c, 52d telescope within each other when the foot pedal 26 (see FIG. 1) is depressed. In addition, other variables that impact the spring characteristic of the spring steel coil 52 include a shape of the flat piece of spring steel, shapes of the sub-coils 52a, 52b, 52c, 52d, respective spacings between the sub-coils 52a, 52b, 52c, 52d, and respective heights 54a, 54b, 54c, 54d of the sub-coils 52a, 52b, 52c, 52d, in the free state.

The different variables discussed above for the coil 52 are chosen to achieve a desired spring characteristic, within a predetermined tolerance, that is maintained down to a predetermined temperature. For example, in one embodiment, the variables of the coil 52 are chosen to achieve a spring characteristic improved over a rubber spring, which has a wide spring rate and load tolerance over temperature and operating life. The spring characteristics of the coil 52 are maintained down to a predetermined temperature of about −40° F. and up to about +200° F. In that regard, the variables of the coil 52 and the sub-coils 52a, 52b, 52c, 52d, including the chosen material, discussed above act as means for maintaining the spring characteristic of the coil 52.

With reference to FIGS. 1-5, during use, an operator of the vehicle depresses the foot pedal 26 when it is desired to communicate compressed air to the at least one brake chamber 14 for actuating the service brakes of the vehicle 10. As discussed above, the modulating spring 40 (e.g., the volute spring) biases the foot pedal 26 against the depressible force from the operator of the vehicle 10. The placement of the primary piston retainer 36 and the primary piston 34 has less of an effect on performance than placement of the rubber spring. Because the spring characteristic of the modulating spring 40 (e.g., the volute spring) is maintained down to temperatures of about −40° F. the bias felt by the vehicle operator against the foot pedal 26 remains substantially consistent even when an ambient temperature drops to temperatures of about −40° F. The bias continues to have non-linear characteristics.

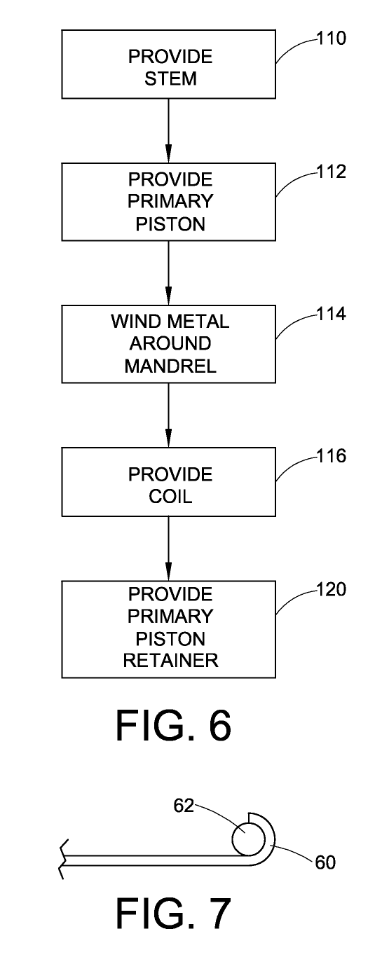

With reference to FIG. 6, an exemplary methodology for manufacturing the foot brake valve 22 used in the vehicle braking system shown in FIGS. 1-5 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

The method of manufacturing the foot brake valve 22 includes, in a step 110, providing the plunger 32 that during use is positioned based on the position of the brake pedal 26. In a step 112, the primary piston 34, which during use is positioned based on the position of the plunger 32, is provided.

With reference to FIGS. 6 and 7, in a step 114, a flat piece of spring metal 60 is wound around a mandrel 62 so that the plurality of sub-coils 52a, 52b, 52c, 52d are formed from the spring metal 60. As discussed above, the plurality of sub-coils 52a, 52b, 52c, 52d are formed to be concentric and telescope within each other. The sub-coils 52a, 52b, 52c, 52d form the coil 52. As discussed above, the different variables of the flat piece of metal 60 (and of the coil 52) are chosen to achieve a desired spring characteristic, within a predetermined tolerance, that is maintained down to a predetermined temperature.

Once the sub-coils 52a, 52b, 52c, 52d are formed, the coil 52 is removed from the mandrel 62. Then, in a step 116, the coil 52 is provided for use in the foot brake valve 22. The primary piston retainer 36 is then provided in a step 120.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A foot brake valve for operating a vehicle brake system associated with wheels of the associated vehicle, the foot brake valve comprising:
a plunger positioned based on a position of an associated brake pedal depressed by an operator for engaging an associated service brakes of the vehicle;
a primary piston positioned based on a position of the plunger; and
a volute spring biasing the primary piston against a depression of the brake pedal.

2. The foot brake valve as set forth in claim 1, wherein:
the volute spring is metal.

3. The foot brake valve as set forth in claim 2, wherein:
the volute spring is steel.

4. The foot brake valve as set forth in claim 1, wherein the volute spring includes:
a flat piece of spring metal around a mandrel.

5. The foot brake valve as set forth in claim 4, wherein:
the flat piece of spring metal winds around the mandrel.

6. The foot brake valve as set forth in claim 4, wherein:
the flat piece of spring metal is wound around the mandrel to form a plurality of coils.

7. The foot brake valve as set forth in claim 6, wherein:
the plurality of coils are concentric.

8. The foot brake valve as set forth in claim 6, wherein:
the plurality of coils telescope within each other.

9. The foot brake valve as set forth in claim 8, wherein:
a spring characteristic of the telescoping coils is determined based on a shape of the flat piece of spring metal.

10. The foot brake valve as set forth in claim 9, wherein:
the spring characteristic, of the telescoping coils is maintained between temperatures of about −40° F. to about +200° F.

11. A vehicle braking system, the system comprising:
a brake pedal depressible by an operator of the vehicle;
a service brake associated with a respective wheel of the vehicle;
a reservoir storing pressurized air for actuating the service brake; and
a brake valve for selectively communicating the pressurized air from the reservoir to the service brake, the brake valve comprising:
a plunger positioned based on a depressed position of the brake pedal for communicating the pressurized air from the reservoir and engaging the service brake;
a primary piston positioned based on a position of the plunger; and
a volute spring biasing the primary piston against a depression of the brake pedal.

12. The vehicle braking system as set forth in claim 11, wherein:
the volute spring is metal.

13. The vehicle braking system as set forth in claim 11, wherein the volute spring includes:
a flat piece of spring steel wound around a mandrel to form a plurality of coils.

14. The vehicle braking system as set forth in claim 13, wherein:
the plurality of coils are concentric and telescope within each other.

15. The vehicle braking system as set forth in claim 14, wherein:
a spring characteristic of the telescoping coils is determined based on a shape of the flat piece of spring steel.

16. A method of manufacturing a foot brake valve, the method comprising:
providing a plunger that is positioned based on a position of an associated brake pedal depressed by an operator for engaging an associated service brakes of the vehicle;
providing a primary piston positioned based on a position of the plunger; and
providing a volute spring that biases the primary piston against a depression of the brake pedal.

17. The method of manufacturing a foot brake valve as set forth in claim 16, wherein the step of providing the volute spring includes:
winding a flat piece of spring metal around a mandrel.

18. The method of manufacturing a foot brake valve as set forth in claim 17, wherein the step of winding includes:
forming a plurality of coils around the mandrel.

19. The method of manufacturing a foot brake valve as set forth in claim 18, wherein the forming step includes:
forming the coils to be concentric and telescope within each other.

20. The method of manufacturing a foot brake valve as set forth in claim 18, wherein the forming step includes:
forming the coils to maintain a spring characteristic between temperatures of about −40° F. to about +200° F.

21. A foot brake valve for operating a vehicle brake system associated with wheels of the associated vehicle, the foot brake valve comprising:
a plunger positioned based on a position of an associated brake pedal depressed by an operator for engaging an associated service brakes of the vehicle;
a primary piston positioned based on a position of the plunger;
a modulation spring controlling, in response to an operator depressing the brake pedal, an amount of the compressed air delivered to the service brakes, the modulation spring biasing the primary piston against a depression of the brake pedal; and
means for maintaining a spring characteristic of the modulation spring between a temperature of about −40° F. to about +200° F.

22. The foot brake valve as set forth in claim 21, wherein the means for maintaining the spring characteristic includes:
the modulation spring formed as a volute spring.

23. The foot brake valve as set forth in claim 22, wherein:
the volute spring includes a plurality of coils having respective heights in a free state.

24. The foot brake valve as set forth in claim 22, wherein:
the volute spring is formed from a flat piece of spring steel; and
the spring characteristic of the volute spring is maintained by a shape of the flat piece of spring steel.
